(19) United States
(12) Patent Application Publication
(10) Pub. No.: US 2004/0123324 A1
(43) Pub. Date: Jun. 24, 2004

(54) Methods and apparatus for providing video services such as Video-on-Demand, news and advertising services

(76) Inventors: Sharif M. Sazzad, Monmouth Junction, NJ (US); Larry Pearlstein, Newtown, PA (US)

Correspondence Address: STRAUB & POKOTYLO, 620 TINTON AVENUE, BLDG. B, 2ND FLOOR, TINTON FALLS, NJ, 07724, US

(21) Appl. No.: 10/731,756

(22) Filed: Dec. 9, 2003

Related U.S. Application Data
(62) Division of application No. 09/517,115, filed on Mar. 7, 2000.

(51) Int. Cl. H04N 7/173

(52) U.S. Cl. 725/89; 725/101; 725/102; 725/100; 725/95; 725/86; 725/88; 725/90

(57) ABSTRACT

Methods and apparatus for distributing multi-media data, e.g., video and audio data, corresponding to television programs, movies, local advertising, etc. are described. Video on demand services such as pay-per-view (PPV) services are supported by caching initial portions of PPV programs in user devices such as cable set top boxes and satellite receivers. In response to a request for a PPV movie, the user is immediately presented with the movie by outputting data corresponding to the requested program from the cache. During the presentation of the PPV program to the user, the cached data is supplemented with broadcast data obtained from a time staggered repetitive broadcasting of the requested PPV movie. A variety of regional news programs are also made available to a user of the invention through the use of program segment caching. Regional news program segments are cached prior to presentation time. At presentation time, regional news segments corresponding to a user selected regional news program are retrieved from the cache and combined with broadcast non-regional news segments. By stitching together cached non-regional news segments and regional news segments, a wide variety of regional news programs can be provided to the user without having to broadcast complete copies of the regional news programs. Program segment caching and stitching is performed at the user premises reducing the complexity of the centralized server.

### FIELD OF THE INVENTION

The present invention relates to methods and apparatus for distributing multimedia data, e.g., movies, news, videos, etc. in a customized manner, e.g., in response to local needs or requests of individual subscribers.

### BACKGROUND

Multimedia data, e.g., data corresponding to multiple presentation medias, e.g., audio and video medias, is commonly used to provide a wide variety of services from television, news shows, movies, etc. Methods for distributing multimedia data vary from, e.g., television broadcasts, cable networks, and satellites.

A goal of many multimedia distribution systems has been to provide users content, e.g., moves or news broadcasts, specifically directed to the particular needs, wants or desires of individual users. For example, national satellite and cable providers have been striving to find ways of providing local news content to specific regions of the country while broadcasting from a single site, e.g., a single satellite. In addition, multimedia distributors have been striving for ways to providing video services on demand to large numbers of customers in a cost effective manner.

Video services which include the provision of, e.g., movies, news shows, and sitcoms, continue to expand. Unfortunately, given the current forms of video distribution, e.g., cable, satellite broadcasts, etc., the provision of video on demand and/or customized local news services remains difficult and/or expensive to provide.

A Video-On-Demand (VoD) system is one in which a user of a video or multimedia broadcast network is able to receive video service upon demand. In the case of video on demand services, a user of a service is allowed to select what he/she wishes to view and is then able, ideally, to view the requested video at a time of the user's choosing. Often, VoD services are provided to users for a fee. In fact, VoD service in the form of Pay-Per-View (PPV) is an extremely profitable business for cable and satellite broadcasters.

VoD systems can be characterized as immediate VoD systems (iVoD) or near VoD (nVoD) systems. In iVoD systems, a user of the system can select an item, e.g., a movie, for immediate viewing or for viewing at any time desired by the user. In nVoD systems, a user can select an item, e.g., movie, for viewing at any one of a plurality of different set times at which the item is being offered for viewing.

In some known iVoD systems, a large centralized server is used to provide Video-On-Demand service including features like stop, play and rewind, all from a main server. Such systems are complicated by the need to be able to provide different video streams on demand to each of the users coupled to the main server. Such distribution requirements are often in contrast to the distribution capabilities available in most modern cable systems where the same video signals are frequently supplied to all users on a given branch of the cable network. Such implementations of iVoD systems also have the disadvantage of requiring relatively powerful and therefore expensive centralized servers capable of responding to video requests and commands from multiple users at the same time.

Unfortunately, due to the bandwidth limitations of available communications systems which service multiple subscribers and/or the cost of providing a centralized server capable of providing different video streams to multiple subscribers, it is often not commercially feasible to provide instantaneous video on demand services to multiple subscribers using the known centralized video server systems.

Given the implementation difficulties associated with the known centralized iVoD systems, at the present time, Pay-Per-View (PPV) is implemented mostly as a form of a near Video-On-Demand (nVoD) service.

In various known nVoD systems, multiple instances of PPV programming are presented in a time-staggered manner. This is illustrated in FIG. 1. In the FIG. 1 example, there are four time-staggered instances of a program and each instance of the program is identified by a number in parentheses, e.g. program(0). Each instance of a program may be encrypted or scrambled to prevent service users from viewing the movies without authorization. In the illustrated system each instance of the program exists in a separate channel. The duration of the program is L time units and there is an inter-program delay, D, that separates presentations of a program on the same channel. The subscriber to a nVoD-based PPV service normally requests programming during a particular time period. The subscriber is then presented with the requested program at the end of a delay period between program presentations. Presentation of the program to the subscriber may involve providing the subscriber with, e.g., a decryption key or a descrambling authorization code required to view the program. An addressable cable converter or satellite receiver may be used to control presentation and decryption/descrambling of the selected program.

Accordingly, users of known nVoD systems normally must wait until the start time of the next instance of a selected program before they can begin viewing the program.

Staggering the presentation of multiple instances of a program in the described known manner makes it possible to provide a near VoD service in which the maximum wait time of a user is reduced proportional to the number of program instances. However, nVoD systems are limited by the number of available channels and by the economics of offering many instances of a few programs. This has the effect of forcing a trade-off between the number of unique services offered and number of instances of offered programs. By offering fewer instances of a program, longer wait times result thereby reducing the quality of the on-demand experience.

In addition to wait times, another problem with known nVoD systems, where programs are displayed as they are received, is that they deny the user the ability to stop, fast forward or reverse the program being displayed.

In order to provide limited stop, fast forward and reverse capabilities buffers are now being built into some set top cable decoder boxes. Such boxes buffer a segment of a program and then allow a viewer, within the limits of the buffered program segment, to fast forward, pause and reverse the displayed image. In such decoder boxes the contents of the buffer are updated with the program as it is received with the oldest portion of the buffer dedicated to the program being overwritten by the most recent program data. While the use of buffering provides some fast forward, pause and reverse capability, it does not address the problem of wait times associated with known nVoD systems.

While wait times associated with nVoD systems represent one area of video service where improvement would be useful, there is also a need for improvements in broadcast news in regard to the provision of local news content. In the case of satellite and other news broadcasts originating from one or a few transmission sites which service a large area of the country, viewers are often deprived of local news due to the national broadcasters unwillingness to dedicate the bandwidth required to transmit a large number of very similar news programs each of which may actually include only a small amount of local news which is distinct from the news included in the other broadcasts.

In view of the above discussion, it becomes apparent that there is a need for improved methods and apparatus for providing, e.g., distributing and presenting, multimedia data to individuals. It is desirable that at least some methods and apparatus be capable of providing iVoD services and/or improved nVoD services with low wait times. From a backwards compatibility standpoint, it is desirable that at least some of the new broadcast methods and apparatus be compatible with existing cable boxes and/or set top decoders, thereby allowing gradual system upgrades without rendering existing devices unusable. It is also desirable that at least some methods and apparatus be capable of providing local news and other targeted content to users while still permitting a centralized, e.g., national satellite based, broadcasting system.

### SUMMARY OF THE INVENTION

The present invention is directed to methods and apparatus for distributing multi-media data, e.g., video and audio data, corresponding to television programs, movies, etc.

In accordance with one embodiment of the present invention, a communication system is based on a distributed architecture where a centralized video server is responsible for providing certain functions and local presentation devices, e.g., set-top boxes, are responsible for performing many of the operations associated with specific user requests. Server functions may include, e.g., repetitive distribution of pay-per-view programs on a time staggered basis, distribution of regional and non-regional news segments and programs, and/or distribution of program information. The distributed program information may include, e.g., the time and channel used to transmit a particular program or program segment, information on the program segments which are to be combined to form a complete program such as a regional news program, and/or user authorization information authorizing specific user devices to present various pay-per-view or other program offerings.

User requests which the local presentation devices, e.g., set-top boxes, are responsible for servicing include fast-forward, reverse, stop, and play requests. More significantly however, in response to a request for a pay-per-view program or regional news program, the local user devices, e.g., set top boxes, of the present invention are responsible for generating the program to be presented from locally cached program data, e.g., program segments, and program data which is transmitted to the local user device, e.g., subsequent to a user requesting presentation of a specific pay-per-view program or the beginning presentation time, e.g., start time, of a regional news program. Thus, in accordance with the present invention, local presentation devices are used to generate programs by combining or “stitching together” broadcast program data with previously cached program data.

To facilitate the generation of programs from cached and broadcast program segments, accurate program timing information, e.g., time stamps or time codes, are included in both the cached and transmitted program segments. For example, in the case of digital Video-On-Demand systems, Real-Time Transport Protocol (RTP) may be utilized. RTP is described in a document published by the Network Working Group, as RFC 1889, titled: “RTP: A Transport Protocol for Real-Time Applications” (January 1996) In accordance with RTP, RTP time-stamps are included in the program segments and it is these time stamps which may be used to convey the necessary timing information. Another method for conveying program timing information, which may be used with the present invention is Normal Play Time (BPT), as defined in ISO/IEC 13818-6 titled: “Extension for Digital Storage Media Command and Control” (Draft July 1996).

Thus, as will be discussed further below, the present invention utilizes the caching of program segments at a local site, e.g., at each user device, to facilitate the provision of various services. When providing VoD and improved nVoD services, initial portions of each unique pay-per-view program being offered is cached. When a user of the system requests a specific pay-per-view program the corresponding cached segment is played back and additional video data obtained from a broadcast version of the program is used to supplement the cached program data allowing presentation of the full program with little or no wait time before the program is presented to the user.

The initial program segment caching and playback techniques of the present invention allow for the provision of VoD services or improved nVoD services, in communication systems which already support nVoD services through use of multiple time staggered broadcasts of pay-per-view programs. The VoD services or improved nVoD services of the present invention can be provided in such known systems without rendering existing set-top boxes unusable thereby avoiding the need to replace existing user set top boxes.

As will be discussed below, the feature of the present invention which supports caching of regional news segments allows for regional news programs, with both regional and non-regional program content, to be presented to a user. Thus, users can view regional news programs without the need to broadcast the non-regional program content with each regional news program. Thus, customers of a centralized broadcast system such as a satellite TV system can receive local news broadcasts without requiring the broadcaster to transmit complete local news programs on numerous channels.

Additional features, embodiments and benefits of the methods and apparatus of the present will be discussed below in the detailed description which follows.

### BRIEF DESCRIPTION OF THE DRAWINGS

FIG. 1 illustrates a known process of transmitting multiple instances of the same program in a time staggered manner.

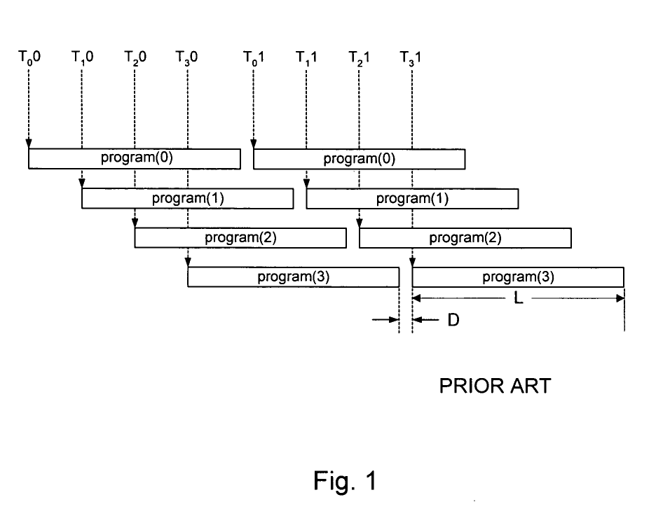

FIG. 2 illustrates a communication system implemented in accordance with the present invention.

FIG. 3 illustrates a routine used for controlling operation of the video server illustrated in FIG. 2 in accordance with the present invention.

FIG. 4 illustrates the communication system of FIG. 2, with the user device being shown in greater detail.

FIG. 5 illustrates a control routine used for controlling operation of a user device in accordance with the present invention.

FIG. 6 illustrates a VoD pay-per-view presentation routine used for controlling the display of pay-per-view programs in accordance with the present invention.

FIG. 7 illustrates a regional news presentation routine used for controlling the display of regional news programs in accordance with the present invention.

FIG. 8 illustrates a plurality of regional news programs and a non-regional news program each of which includes a plurality of news segments in accordance with the present invention.

FIG. 9 illustrates the broadcasting of a PPV program on two channels.

FIG. 10 illustrates various aspects of stitching streamed program data and cached program data together in accordance with the present invention.

FIG. 11 illustrates the broadcasting of a PPV program on four channels.

### DETAILED DESCRIPTION

The present invention relates to methods and apparatus for distributing multimedia data, e.g., movies, news, videos, etc. in a customized manner, e.g., in response to local needs or requests of individual subscribers. In accordance with various embodiments of the present invention, VoD, improved nVoD and/or regional news services are provided to users of the communication system of the present invention. This is done through the use of cached program data and program data which is received subsequent to the start of the presentation of a program to a user.

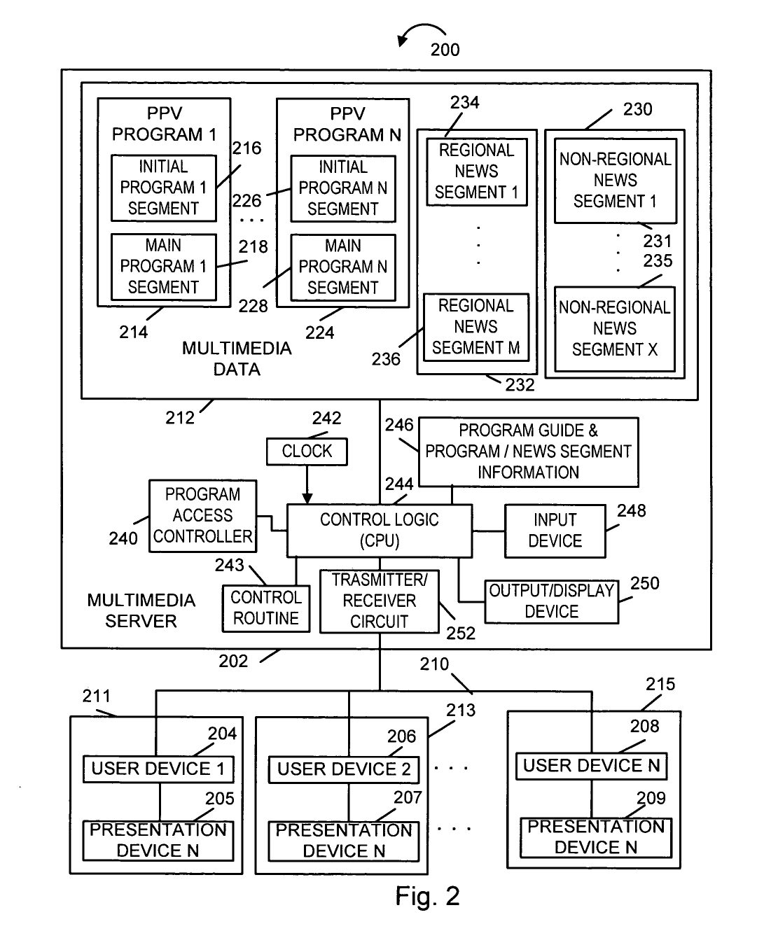

FIG. 2 illustrates a communication system 200 implemented in accordance with an exemplary embodiment of the present invention. As illustrated, the communication system includes a multimedia server 202, e.g., video program server, for transmitting multi-media data, e.g., video and audio data, to a plurality of local user devices 204, 206, 208. The multi-media data may be transmitted via a cable connection or other communications medium 210. The communications medium may include, e.g., a satellite, and/or television broadcasting system. Each user device is coupled to a corresponding presentation device 205, 207, 209. The presentation devices 205, 207, 209 may take the form of, e.g., a television set or computer monitor. Each user device and corresponding presentation device is normally located on the premises 211, 213, 215, e.g., home, hotel room or office, of a different user.

The multimedia server 202 comprises a set of multimedia data 212, program guide & program/news segment information 246, a clock 242, program access controller 240, input device 248, output/display device 250, transmitter/receiver circuit 252, control routines 243 and control logic, e.g., a CPU 244.

The multimedia data 212 may be stored in RAM, or non-volatile storage such as a hard disk drive array or any one of a plurality of known storage devices. The multimedia data 212 comprises a plurality of N pay-per-view (PPV) programs, 214, 224, a set 232 of regional news segments and a set 230 of non-regional news segments. In addition to the news segments and pay-per view programs, the multimedia data 212 may include non-pay preview movies, television shows, etc.

In accordance with the present invention, the PPV programs 214, 224 and news segments include timing information which can be used for segmenting video segments and/or combining video segments in a consistent manner. For purposes of illustration, PPV programs 1 through N are each illustrated as being comprised of an initial program segment 216, 226 and a main program segment 218, 228, respectively.

The set 234 of regional news segments includes a first through M^{th} regional news segments 234, 236 while the set 230 of non-regional news segments includes first though X^{th} non-regional news segments 231, 235. As will be discussed below, non-regional news programs comprise one or more non-regional news segments. In contrast to non-regional news programs, regional news programs normally comprise one or more regional news segments in addition to some non-regional news segments. In fact, the truly regional news content of a regional news program frequently tends to be relatively small compared to the non-regional content of the regional news program. This fact makes it practical to cache multiple regional news segments and then to combine them at presentation time with broadcast non-regional news segments to effectively construct regional news broadcasts on the fly at presentation time. By caching regional news segments in accordance with the present invention and combining them at presentation time with non-regional news segments, multiple regional news programs can be supported using a fraction of the transmission bandwidth that would be required to transmit to each user device 204, 206, 208 a complete version of each regional news program in addition to one or more non-regional news programs.

The program guide & program/news segment information 246 includes information on the broadcast times of the N PPV programs 214, 224. It also includes information on the broadcast times of the regional news segments 234, 236 as well as the non-regional news segments 231, 235. Along with broadcast time information, the information 246 may include information on how to construct multiple regional and/or non-regional news programs from the transmitted regional and non-regional news segments. For example, for each supported regional and non-regional news program, the information 246 may include a list of news segments which form the program, segment order information, and news segment presentation time information. Such information is used, as will be discussed further below, by a user device of the present invention to generate, at presentation time from the various news segments, a particular news program selected by the user for viewing.

Operation of the multimedia server 202 is controlled by control logic 244 in accordance with instructions included in a server control routine 243. The clock 242 provides timing information to the control logic 244. The server control routine 243, when executed by the control logic 244, causes the server 202 to transmit the data 214, 224 representing the PPV programs and the data 232, 230 representing the regional and non-regional news segments, at the times indicated by the program guide & program/news segment information 246. Each of the PPV programs 214, 224 is transmitted repeatedly on one or more transmission channels allowing for both nVoD services and VoD services in accordance with the present invention. The transmission channels may be separate physical channels, separate logical channels on the same physical channel, or a combination of these. As will be discussed below, in systems where all user devices which are to support the presentation of PPV programs include the ability cache initial program segments, the initial PPV program segments 216, 226 may be transmitted once with the main program segments 218, 228 being transmitted repeatedly on a time staggered basis.

Transmitter/receiver circuit 252, operating under control of the control logic 244, is responsible for performing the actual operation of transmitting the program data and news segments. The transmitter/receiver circuit 252 is also responsible for receiving program access requests from user devices. The control logic 244, operating in conjunction with the program access controller 240, issues users requesting to view PPV programs the encryption/descrambling or other authorization information required for the requesting user to be presented with a PPV program. The program access controller 240 also keeps track of billing data.

The input device, e.g., keyboard, 248 may be used for inputting sever control information, for updating the program guide information 246 or for otherwise supplying input to the server 202, e.g., for system maintenance purpose. Output device 250 can be used for displaying multimedia status information as well as other system information.

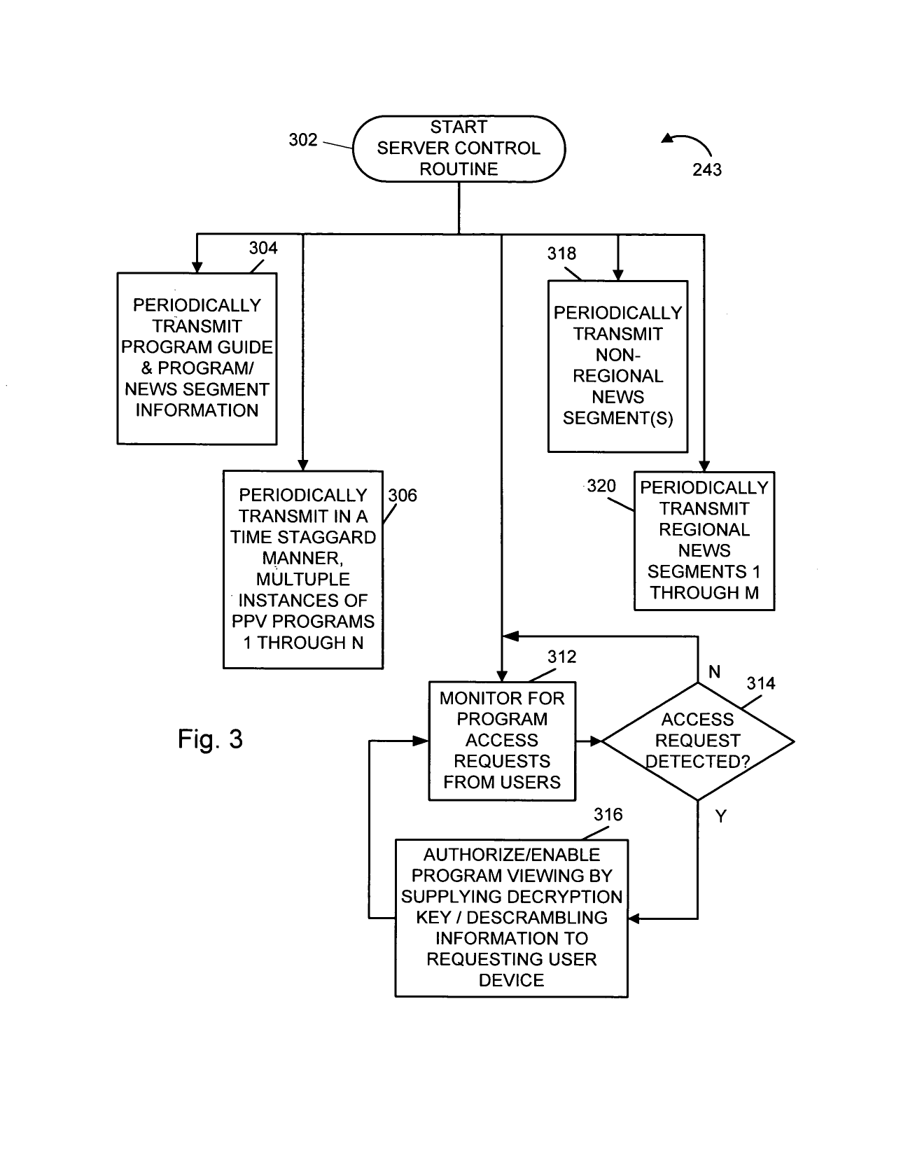

FIG. 3 illustrates the steps included in an exemplary server control routine 243. The control routine 243 begins in start step 302 with the routine being loaded and executed by control logic 244. From step 302, operation proceeds to a plurality of steps, e.g., steps 304, 306, 312, 318, and 320 which may be performed in parallel.

In step 304, the server is controlled to periodically transmit program guide & program/news segment information 246. The transmission of this information may be performed on a regular predictable schedule, e.g., every minute or every few minutes.

In step 306, the server 202 is controlled to periodically transmit, in a time staggered manner, multiple instances of PPV programs 1 through N. In step 318, the server 202 is controlled to periodically transmit non-regional news segments, e.g., one or more segments in the set of non-regional news segments 230. Similarly, in step 318, the server 202 is controlled to periodically transmit regional news segments, e.g., one or more segments in the set of regional news segments 234. The periodic transmission of the PPV programs, regional news segments and non-regional news segments is performed by the server 202 in accordance with the transmission time information included in the program guide & program/news segment information 246.

In addition to transmitting programs and program segments, the server 202 is responsible for authorizing user devices to present PPV programs to requesting users. In step 312 the server is operated to monitor for PPV program access requests from users. Operation proceeds from step 312 to step 314 wherein a determination is made as to whether a PPV program access request was detected. If a PPV access request is not detected operation proceeds once again to monitoring step 312. If in step 314 a determination is made that a PPV program access request was detected, operation proceeds to step 316. In step 316, the detected access request is processed. Assuming that the request is from a user in good standing, in step 316, the user device from which the request originated is authorized to present the requested PPV program to the requesting user. This may involve enabling program viewing by supplying a decryption key and/or descrambling information to the requesting user device. In step 316 user billing information maintained by the server may be updated to reflect a charge for viewing the user requested PPV program. Operation proceeds from authorization step 316 to monitoring step 312.

The various steps in the server control routine are performed, once started, until stopped, e.g., by shutting down the server 202.

Having described operation of the multimedia server 202 in detail, operation of a user device which can receive multimedia data and other information from the server 202 will now be discussed at length.

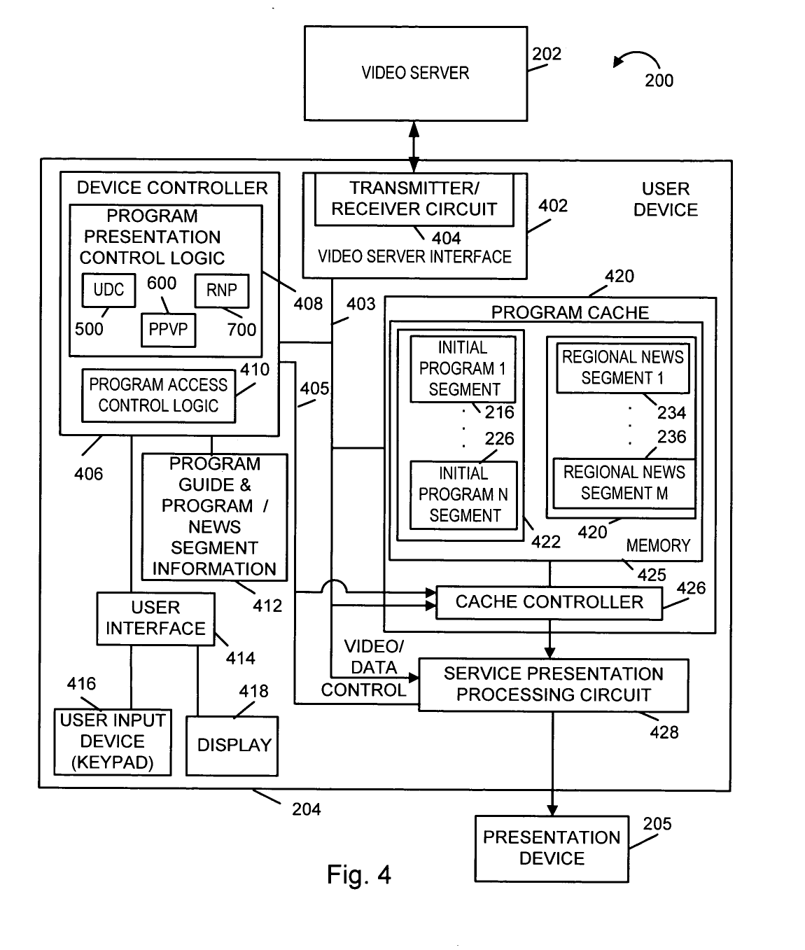

FIG. 4 illustrates an exemplary user device, e.g., device 204, implemented in accordance with the present invention. The user device, e.g., set top cable box or satellite receiver, comprises a video server interface 402, a device controller 406, program cache 420, user interface 414, user input device 416, display 418, program guide & program news segment information 412 and service presentation processing circuit 428.

The video server interface 402 includes a transmitter/receiver circuit 404 for sending, e.g., PPV program access requests, to the multimedia server 202 and for receiving program data, e.g., PPV program segments, news segments, and program guide & program/news segment information from the multimedia server 202. Via the circuit 404, the user device 204 can also receive decryption codes, descrambling information and/or other information required to present a PPV program to a user.

The video server interface 402 is coupled to the various components 406, 402, 420, 428 of the user device 204 via video/data bus 403. Program guide & program/news segment information received from the video server is stored in memory segment 412 under control of the device controller 406. The device controller 406 is responsible for controlling the overall operation of the user device 204 in accordance with program presentation control logic 408 and program access control logic 410 included in the device controller 406.

The device controller 406 is coupled to a user input device 416 and a display device 418 through user interface 414. The user input device may be, e.g., a keypad or a remote control through which a user can make channel selections, news program selections and/or PPV program selections. The display device 418 may be a LCD or other type of display for displaying channel, time and/or program information. Display 418 may be omitted in embodiments where the display of the presentation device 205 is used to present an on-screen menu of programs, control options, and other information, e.g., program guide information, to a user of the device 204. While presentation device 205 is illustrated as being a separate component from user device 204, it may be incorporated into the user device to provide, e.g., a cable or satellite ready TV or multimedia device.

Device controller 406 operates under control of program access control logic 410 and program presentation control logic 408. Program access control logic 410 can be used, in response to user settings, to block certain channels or programs from being displayed.

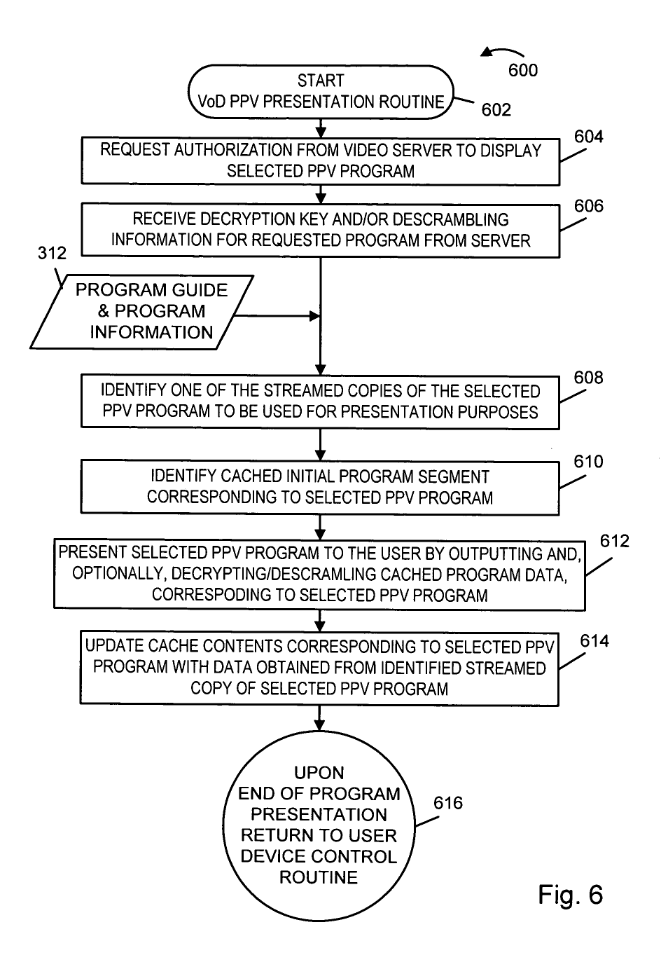

Program presentation control logic 408 is used to control the storage of program data and information and the presentation of programs to the user. Program presentation control logic 408 includes a user device control (UDC) routine 500, a VoD PPV presentation (VoD PPVP) routine 600 and a regional news presentation (RNP) routine 700. Each of these control routines will be discussed further with regard to FIGS. 6, 7, and 8, respectively.

The device controller 406 interacts with the program cache 420 and service presentation processing circuit 428 via control bus 405 and video/data bus 403.

The program cache 420 includes a cache controller 426 which is responsible for identifying, e.g., from program information 412 supplied to it from the device controller 406, program segments e.g., initial PPV program segments 422 and regional news segments 420 which are to be stored in the cache. It is also responsible for storing the identified program segments to be cached in cache memory 425 and for retrieving from the cache memory program segments as needed for presentation purposes under control of control logic 408. In one embodiment, cache memory 425 is implemented as a combination of hard disk storage and RAM chips.

Under control of the device controller 406, the cache controller 426 updates the contents of the program cache, corresponding to a particular program being presented to a user, with data obtained from the video server 202. Previous contents of the program cache corresponding to a PPV program which have already been presented to the user may be overwritten as part of the cache updating process. As will be discussed below, updating of the cache contents corresponding to a particular program and the reading out of the cache contents corresponding to the program is performed in various embodiments on a (first-in, first-out) FIFO basis. This effectively “stitches” together received program data with previously cached program data, thereby producing, at the output of the cache, a continuous and complete set of program data. This allows for a complete PPV program to be presented to a user without having to store the complete PPV program at any one time.

Video data retrieved from the program cache is supplied via the cache controller 426 to the service presentation processing circuit 428. The processing circuit 428, under control of the device controller 406, decrypts/descrambles PPV programs being presented. It also serves as an interface between the program cache and the presentation device 205 used to display the program or programs being presented. In the case of news programs, the service presentation processing circuit 428 may be used to combine cached regional news segments with non-regional news segments received from the video server 202. In this manner, a complete regional news program may be presented to a user without the need to store data corresponding to non-regional program segments.

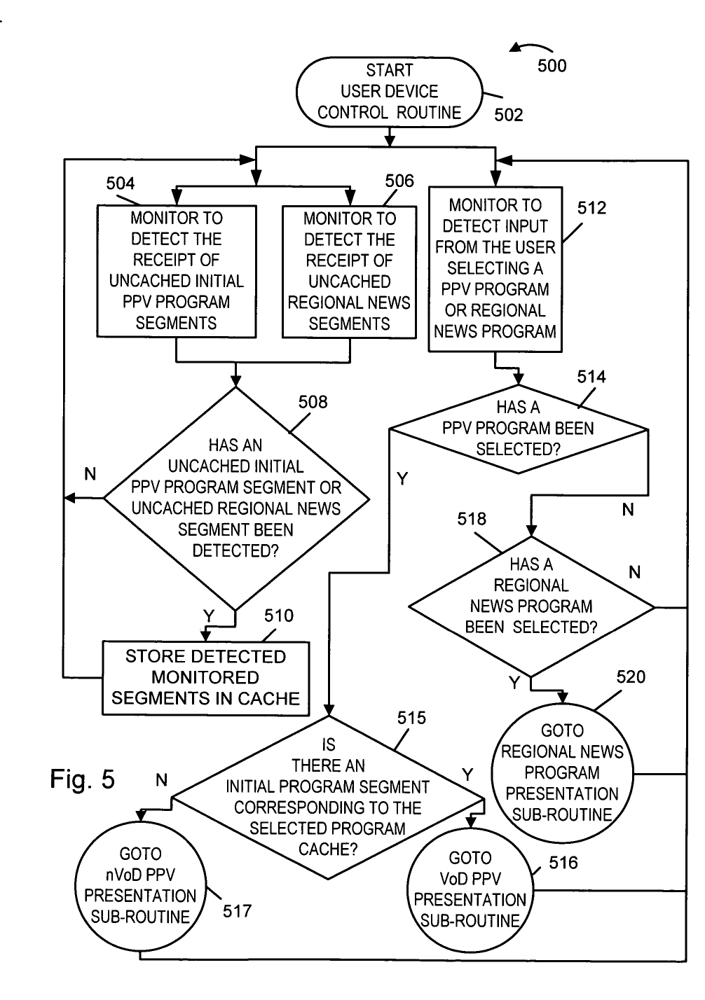

FIG. 5 illustrates the steps of the user device control routine 500 which is used to control operation of a user device, e.g., device 204, in accordance with the present invention. As illustrated, the routine 500 begins in step 502 wherein it is executed by the device controller 406. From step 502, operation proceeds to steps 504, 506 and 512 which may be performed in parallel.

In steps 504 and 506, the program data received from the server 202 is monitored to detect data, e.g., program segments which should be cached. The monitoring may be performed as a function of received program guide & program/news segment information which may identify to device controller 406 the times at which program segments to be cached will be transmitted.

In step 504, the device controller 406 monitors to detect the receipt of uncached initial PPV program segments. In step 506, the device controller 406 monitors to detect the receipt of uncached regional news program segments. Operation proceeds from steps 504, 506 to step 508. In step 508 a determination is made as to whether or not an uncached initial PPV program segment or an uncached regional news segment was detected in steps 504, 506. If either an uncached initial PPV program segment or an uncached regional news segment was detected operation proceeds to step 510, otherwise operation proceeds from step 508 back to monitoring steps 504, 506.

In step 510, the cache controller 426 is controlled to store the detected uncached initial PPV program segment or uncached regional news segment in the program cache 425. Operation proceeds from step 510 back to monitoring steps 504, 506.

In addition to monitoring for the receipt of uncached program segments, the device controller 406, in step 512, monitors to detect input from the user selecting, e.g., requesting, a PPV program or regional news program for viewing. Operation proceeds from step 512 to step 514. In step 514 a determination is made as to whether or not a PPV program has been selected.

If a PPV program has been selected, operation proceeds to step 515. In step 515, a determination is made as to whether or not an initial program segment corresponding to the user selected PPV program exists in the program cache 420. If an initial program segment corresponding to the selected program is not present in the program cache 420 operation proceeds to step 517. Step 517 is a GOTO nVoD PPV presentation sub-routine step wherein operation proceeds to a conventional nVoD presentation routine prior to operation returning to step 512. Since the nVoD PPV presentation sub-routine which is accessed in step 517 is implemented in a conventional manner, it will not be described further herein.

However, if in step 515 it is determined that an initial program segment corresponding to the user selected PPV program is present in the program cache 420, operation proceeds to step 516. Step 516 is a GOTO VoD PPV presentation sub-routine step which serves to initiate operation of the VoD PPV presentation sub-routine 600. Upon returning from the VoD PPV presentation sub-routine 600, operation proceeds from step 516 once again to monitoring step 512.

In step 514, if it was determined that a PPV program was not selected, operation proceeds to step 518 wherein a determination is made as to whether or not a regional news program was selected for viewing. If it is determined that a regional news program was not selected for viewing, operation proceeds from step 520 to monitoring step 512.

If, however, in step 518 it is determined that a regional news program was selected for viewing, operation proceeds to step 520. Step 520 is a GOTO regional news program presentation sub-routine step which serves to initiate operation of the regional news program presentation sub-routine 700. Upon returning from sub-routine 700, operation proceeds from step 520 once again to monitoring step 512.

The VoD PPV presentation routine 600 will now be described with reference to FIG. 6. The routine 600 begins in step 602 and proceeds to step 604. In step 604, the user sends a request to the multimedia server 202 requesting authorization from the server 202 to display the PPV program selected by the user. Following the authorization request made in step 604, operation proceeds to step 606 in which the user device receives a decryption key and/or descrambling information which can be used to decrypt/descramble the requested program. Then, in step 608, the program guide and program information 312 is used to identify for presentation purposes, one of the copies of the selected PPV program, which is periodically transmitted by the server 202.

From step 608 operation proceeds to step 610 in which the cached initial program segments corresponding to the selected PPV program is identified. Then in step 612, the user is presented with the selected PPV program by outputting to the user's presentation device, e.g., device 205, cached program data corresponding to the selected PPV program. As part of the process of presenting the cached program data to the user, the PPV program may be decrypted/descrambled by the service presentation processing circuit 428 using the decryption/descrambling information obtained from the server 202.

While the cached PPV program data is being displayed, in step 614, the cache contents corresponding to the PPV program being presented to the user are updated with data obtained from the transmitted copy of the program identified in step 608. The updating of the cached program contents continues until the program data corresponding to the end of the selected program is cached. The PPV presentation routine 600 stops in step 616 when the end of the selected PPV is presented to the user. With the end of the program presentation, operation returns via step 616 to the user device control routine where operation continues at step 512.

The selection of a transmitted copy of a selected PPV program, which occurs in step 608, for purposes of combining the transmitted program data with the cached program data, will now be discussed in detail.

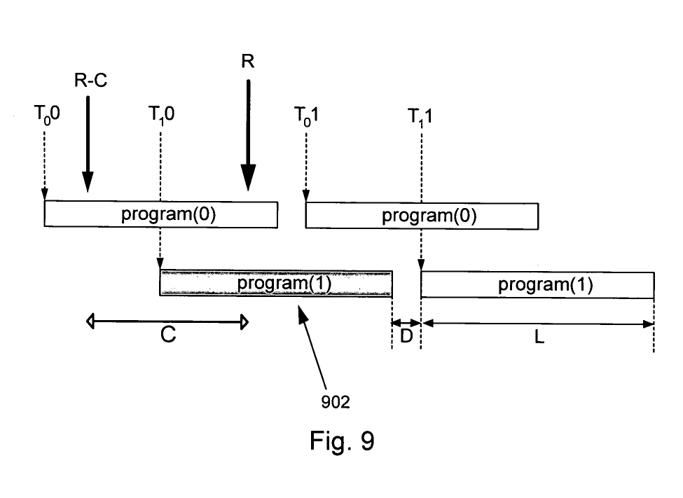

The diagram in FIG. 9 shows a schedule for the time staggered transmission of instances of a PPV program on a first channel (0) and a second channel (1). The PPV program is L time units long and there is an inter program delay of D time units in each program channel. The first instance of the PPV program is scheduled to begin in channel (0) at time T₀0. The second instance of the PPV program is scheduled to begin in channel (1) at time T₁0. The third instance of the PPV program is scheduled to begin in channel (0) at time T₀1. The fourth instance of the PPV program is scheduled to begin in channel (1) at time T₁1.

Given that the broadcasts of the PPV program are staggered in the two channels to provide uniform spacing between program presentations in the FIG. 9 embodiment, it can be seen that, in the given example:

T₁0=T₀0+L/2 (1)

T₀1=T₀0+L+D (2)

T₁1=T₁0+L+D (3)

The actual times for the scheduled start of a program may vary and can be obtained in accordance with the present invention from the transmitted program guide information 412. Thus it is to be understood that equations (1), (2) and (3) are merely exemplary program start time guides provided for purposes of explanations.

The minimum length C of the initial program portion that is cached in the FIG. 9 embodiment to provide VoD service for the transmitted program is determined as follows:

C=L/2+Dₘₐₓ (4)

Where Dₘₐₓ is the maximum delay between presentations of the PPV program in a channel used to broadcast the program. Where program presentations are uniformly spaced, the delay D between each program transmission will be the same and D will equal Dₘₐₓ.

Assuming that a request for service occurs at time R, in step 610 of the PPV presentation routine 600, it is necessary to determine which of the two channels to use as a source of program material. The rule that the program access control logic uses in the case of the FIG. 9 example is:

Select channel K if T_{K}Y>R−C and T_{K}Y<R (5)

Where T_{K}Y indicates the Yth scheduled occurrence of the selected program on the kth channel, in this example T₀0, T₀1, T₁0 and T₁1. In the FIG. 9 example, K may assume the values (0) or (1) since these are the only channels used.

Rule (5), which basically instructs the program access control logic to select the streamed PPV program in which the complete uncached portion of a program will first be available, ensures that the timing of the selected streamed, e.g., broadcast, PPV program is such that the program presentation control logic 408 will have the opportunity to seamlessly stitch together, e.g., concatenate, the cached portion of the program with the streamed uncached portion of the program through control of the cache controller 428.

In the example shown in FIG. 9, the request to view the PPV program occurs at time R. In step 608 the program presentation control logic will compute (R-C) and, after consulting the program guide 412 will determine that program(1) 902 should be used to supplement the cached initial portion of the requested PPV program.

A particularly useful method of combining the cached initial program segment and data obtained from the streamed program is to append the streamed program data to the end of the cached initial program segment data. This may be done by storing the streamed program data selected for use in the cache following the initial program segment data and reading out of the cache in a first-in, first-out manner.

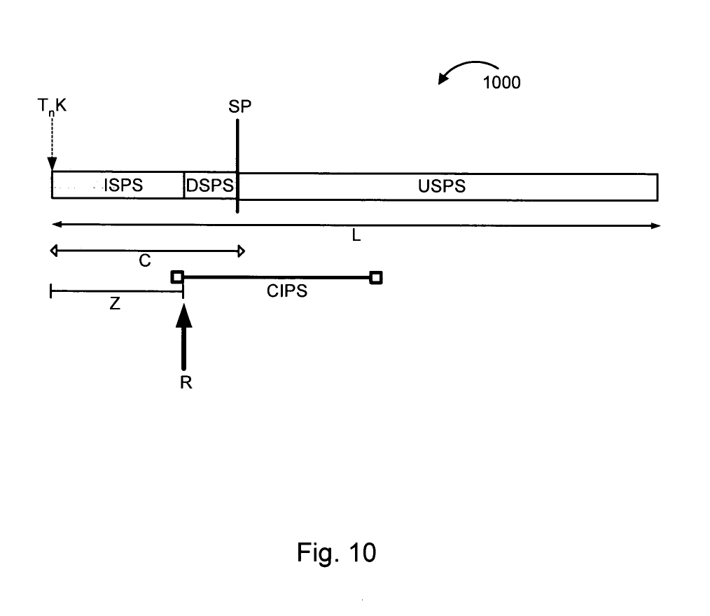

In such an embodiment, the program access control will track the current play time of the selected streamed program, and will discard the program data while the play time is below C time units. Thus, the broadcast data corresponding to the cached initial program segment is ignored or discarded. This method of stitching streamed program data with cached initial program data is illustrated in FIG. 10.

FIG. 10 illustrates a streamed program(n) 1000. The broadcast program(n) 1000 starts at time TₙK and stops L time periods later. For purposes of explaining the stitching of broadcast program data with cached initial program segment data it is assumed that the program presentation control logic 408 has selected the data from program(n) 1000 to be used to supplement the cached initial program segment. The time at which the user initiates a request to view the PPV program of which program(n) is a copy, occurs at time R. Time R occurs Z time periods after the start of program(n). Accordingly, the portion of program(n) prior to time R will have been ignored. Thus, in FIG. 10, the program segment labeled ISPS corresponds to an ignored streamed program segment.

After accessing program(n) in response to the viewing request initiated at time R, the program presentation control logic 408 will extract timing information that is present in program(n) 1000 and will discard the streamed program data that corresponds to the time period after time R and before time (TnK+C). Time (TnK+C) corresponds to the stitch point SP shown in FIG. 10. Thus, the data corresponding to the portion of program(n) labeled DSPS will be discarded.

At time (TnK+C) program presentation control logic 408 begins to stitch the streamed program data that exists after time (TnK+C) to the end of the cached initial program segment, e.g., by storing the data in the same FIFO data structure in which the initial program segment is stored in the cache 425. In this manner, a seamless presentation can be provided to the user by simply reading data out of the cache and processing it, e.g., descrambling or decrypting it, for presentation purposes. Thus, the data corresponding to the portion of program(n) labeled USPS (utilized streamed program segment) will be stitched to the cached initial program segment to provide data corresponding to a complete presentation of program(n).

It should be noted that as an alternative, to the stitching illustrated in FIG. 10, stitching of the cached initial program segment material and streamed program material may be implemented as soon as the timing information of the streamed program has been determined. However, this approach may be less desirable than starting the stitching at the end of the cached programs segment since this method involves storing over the same program material that was already stored, e.g., cached.

The minimum size of the stored initial portion of programming material required to implement a VoD system, as opposed to a nVoD system, depends upon the number of program instances, n, the length of a program and a maximum inter-program delay Dₘₐₓ. Equation (2) was specific for the case where there are two recurring instances of a program being transmitted (n=2), and in general the following rule may be used to determine the lower bound of C:

C=L/n+Dₘₐₓ/(n−1) (6)

where C, L, and Dₘₐₓ are as described above and

where n (N>1) is the number of parallel offerings or instances of a program. Normally, n will equal the number of channels used to offer the same PPV program.

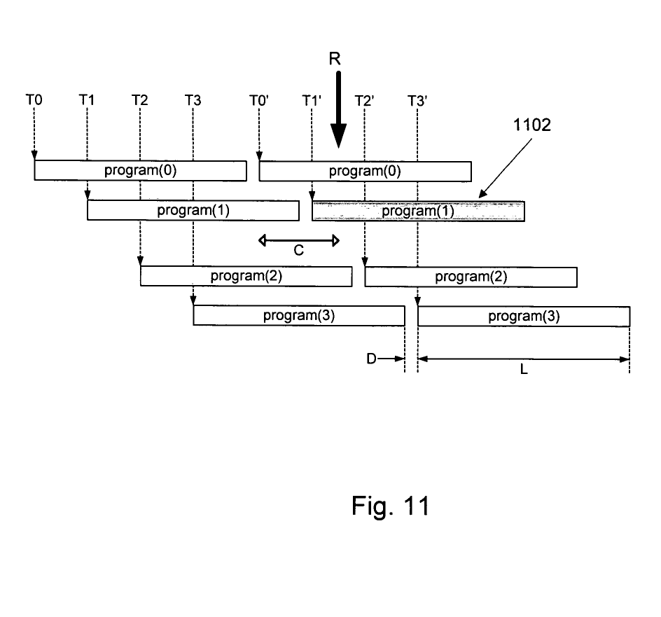

FIG. 11 shows an exemplary program scheduling for n=4. In this case the lower bound, e.g., shortest period of C which will support a VoD system, is computed as follows

C=L/4+Dₘₐₓ/3 (7)

Assuming that the PPV program is segmented into an initial segment and a main program segment, C will equal the maximum delay period which may occur between broadcasts of the main program segment.

In FIG. 11, a user request to view the program occurs a time R. In response to the user request the program presentation control logic 408 will access the scheduling information 412 and determine that the presentation in channel (1) should be selected as the streamed program to be used for stitching purposes. Thus, program (1) 1102 will be selected. With program(1) 1102 having been selected, the program presentation control logic 408 will then access received program(1) data and then examine the timing information included therein to determine when to begin the stitching process.

The use of multiple instances of a program in an nVoD system allows the amount of the initial portion of a program that must be stored to be kept low. This has the benefit of allowing the initial portions of multiple unique programs to be stored using a practical amount of hard disk storage and for the instantaneous Video-On-Demand service to be supported for each of the programs for which an initial program segment is cached. The reduction in the size of the initial program segment which must be cached occurs at the expense of requiring multiple channel resources. However, the costs incurred in providing instantaneous Video-On-Demand service when utilizing the method described in this invention can be much lower than a system in which each individual user is assigned a separate channel resource.

The caching and program stitching methods of the present invention have been described up to this point for use in providing VoD service. However, the initial program segment caching and stitching method of the present invention can also be used to provide improved nVoD service. By caching initial program segments which are of shorter duration than that required for true VoD service, and then by performing program stitching at playback time in the above described manner, an enhanced nVoD service is achieved. The enhanced nVoD service of the present invention will have average wait times which are reduced, e.g., lower than, the average wait times which would result if caching and program stitching were not used.

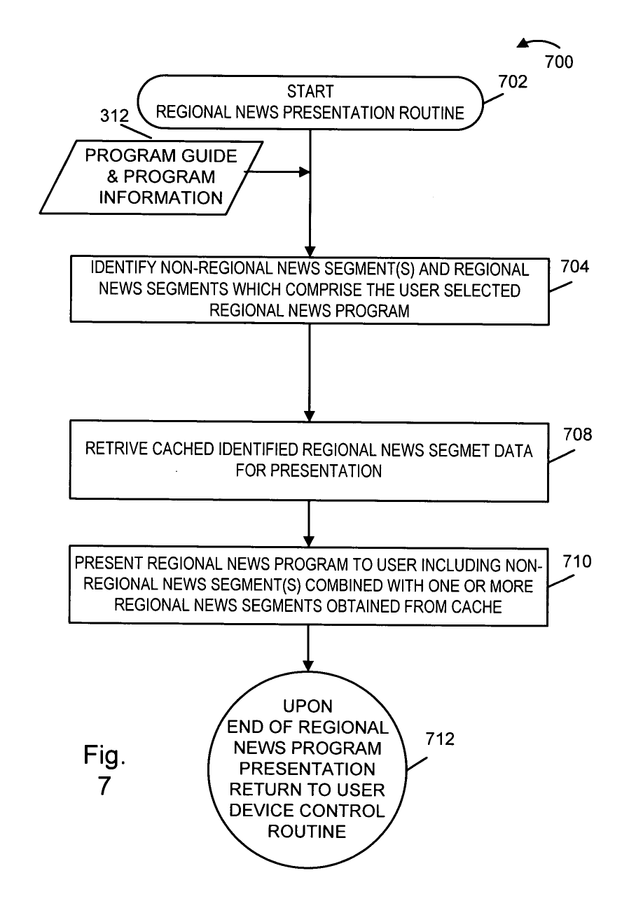

Having described the PPV provisioning features of the present invention in detail, the regional news provisioning features will be described further with reference to FIG. 7. FIG. 7 is a flow chart illustrating the steps of the regional news presentation routine 700.

The regional news presentation routine 700 begins in start step 702 and proceeds to step 704. In step 704, the program guide and program information 312 are accessed to identify non-regional news segments and regional news segments which comprise the user selected regional news program. As discussed above, regional news programs often comprise a large portion of non-regional news. With the segments which comprise the selected regional news program identified, operation proceeds to step 708 wherein program cache is accessed to obtain data corresponding to regional news segments identified in step 704. Then in step 710, the requested regional news program is presented to the user of the system by presenting the identified regional news segments in the order and at the times indicated by the program guide and program information 312. This is done by outputting the cached regional news data and the streamed, e.g., broadcast non-regional news data, at the appropriate times.

Once the regional news program presentation is completed, operation return to the user device control routine via return step 712.

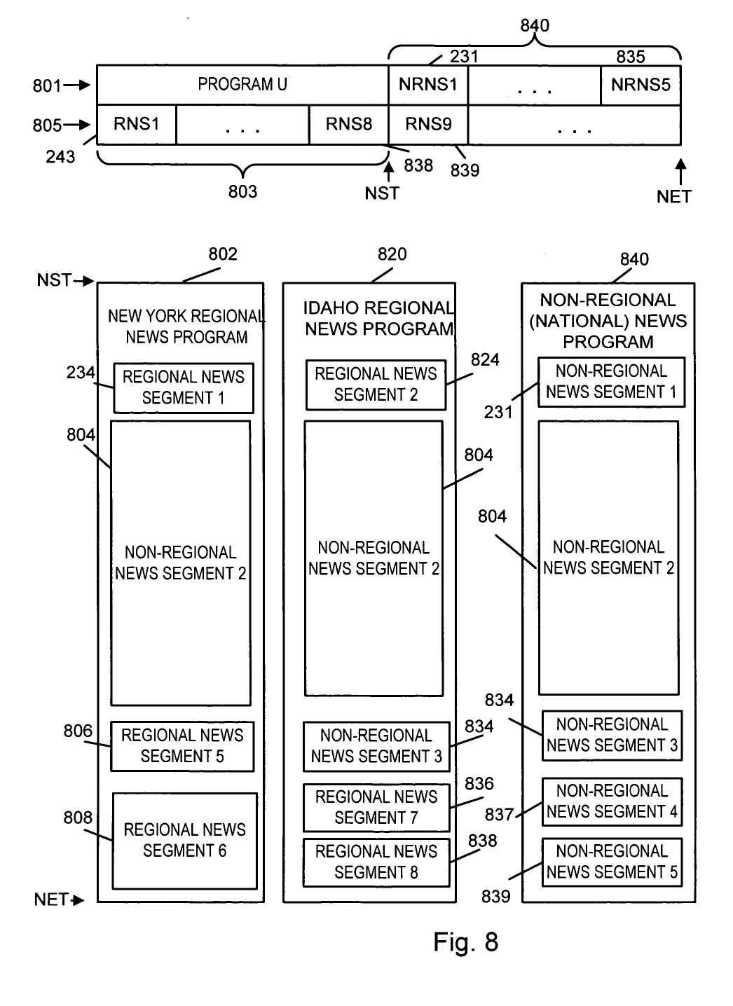

The new program feature of the present invention can be readily understood in view of the examples shown in FIG. 8.

In FIG. 8, row 805 represents the contents of a first communications channel and row 801 represents the contents of a second communications channel. Each channel may correspond to a different broadcast frequency. In the exemplary embodiment, channel 805 is not directly accessible by the viewer in the form of an available channel selection.

The label NST is used to indicate news program start time while the label NET is used to indicate news program end time. For exemplary purposes is assumed that the regional and non-regional news programs have the same start and stop times, e.g., they may all be 30 minute news programs which start at 10 PM and end at 10:30 PM. In such a case NST=10 PM and NET=10:30 PM.

The regional news program segments 803 including regional news segments (RNS) RNS1 243 through RNS8 838 are transmitted prior to the start time NST of the non-regional, e.g., national news program 840 which is comprised of non-regional news segments (NRNS) NRS1 231 through NRNS5 835. While in FIG. 8 the regional and non-regional news segments are shown as being transmitted in separate channels, in various embodiments the non-regional and regional news segments are transmitted in the same channel.

In accordance with the present invention, the regional news segments will be cached in the program cache 420 prior to the news start time. Accordingly, they will be available for presentation at any point during the news presentation period extending from NST to NET.

Since the non-regional, e.g., national, news program 840 is broadcast in complete form, starting at the presentation time, the non-regional program segments need not be cached. However, if segments of the non-regional news program are to be incorporated into a regional news program for presentation at a time which differs from the segment's presentation in the non-regional news program, the segments may be cached for time shifting purposes.

As discussed above, in accordance with the present invention, regional news programs are constructed at presentation time from cached regional news segments and non-regional news segments.

The lower portion of FIG. 8 illustrates how two regional news programs 802, 820 and the non-regional news program 840 may be constructed from the data transmitted in channel 801 and presented to a user between times NST and NET.

The New York regional news program 802 comprises regional news segment 1 234, non-regional news segment 2 804, regional news segment 5 806 and regional news segment 6 808. The regional news program 802 is presented to the user by retrieving and presenting cached regional news segment 1 234, by presenting non-regional news segment 2 804 at the time it is received, followed by presenting regional news segment 5 and 6 806, 808 which are retrieved from the program cache 420 for presentation purposes. Program presentation control logic 408 which controls the cache controller 426 and service presentation processing circuit 428 controls the service presentation processing circuit 428 to switch between outputting the cached and streamed program data at the appropriate times.

The second regional news program, the Idaho regional news program 820, is generated in a similar manner from cached regional news segment 2 824, streamed non-regional news segment 2 804, and cached non-regional news segments 3 (834), 7 (836) and 8 (838).

Non-regional news program 840 is generated by simply presenting non-regional news segments 1 through 5 (231, 804, 837, 839) as they are received.

Exemplary contents of regional news segments 1 and 2 would be customized introductory segments which include information identifying the particular news program being presented. Non-regional news segment 2 may include a story on, e.g., the presidential election or other story of national interest. Regional news segments 3 and 5 may include local weather information. Regional news segments 6 and 7 and 8 may include, e.g., local sports news and/or stories of local interest.

Given that the non-regional news forms a significant portion of regional news programs 802, 820 the technique of the present invention of combining streamed non-regional news segments with cached regional news segments offers an opportunity to provide numerous regional news programs to a user without having to dedicate the bandwidth that would normally be required to transmit complete copies of the regional news programs.

While the same start and stop times are shown for the regional and non-regional news programs, the regional news presentation technique can be used whenever non-regional news broadcasts have a portion of their broadcast time overlapping the presentation time of a regional news program or sufficient buffer space exists to buffer the non-regional news segments included in a requested regional news program.

In accordance with the present invention, the multimedia server 202 is normally located remotely from the customer premises where the user device or devices 204, 206, 208 are located. For example, in one embodiment, user devices 204, 206, 208 are located in individual homes separated by several miles of distance while the server 202 is located at a remote satellite broadcasting device hundreds of miles away.

Variations on the above described exemplary embodiments will be apparent to those skilled in the art in view of the above description of the invention. Such embodiments are considered to be part of the present invention.

For example, local advertisements can be broadcast, cached and then combined with other program segments to form programs with local advertising content in a manner which is the same as, or similar to, the manner in which regional news programs including non-regional news segments are generated. Accordingly, one embodiment of the present invention is directed to the broadcasting of local or regional advertising segments, caching at user devices of the local or regional advertising segments, and the presentation of the local or regional advertising segments along with non-regional program segments, e.g., television program segments. In such an embodiment, the television program presented to the user may be considered a regional program comprising non-regional program segments, e.g., the television program segments, and regional program segments, e.g., the regional advertising segments.

Other examples of regional and non-regional program segments include, e.g., local weather forecasts and national weather information, respectively. In accordance with the present invention, the regional and/or non-regional program segments may be cached and combined to form a complete program, e.g., at presentation time.

While the term time units has been used in the present application, it is to be understood that the particular unit of time is not critical so long as the same units are used to measure the various times discussed herein. For example a time unit may be, e.g., a minute, second or fraction thereof. In addition, while the maximum delay between the presentation of certain programs or program segments is discussed above, it is to be understood that the utilized maximum delay period corresponds to the delay which may occur in a limited preselected period of time, e.g., the maximum delay which will occur during a given day. The maximum delay for a particular program may change on different days or weeks depending on changes in program offerings during the different days or weeks.

What is claimed is:

1. A method of providing a program L time units in length to a user, comprising the steps of:
storing a first segment of said program;
beginning the presentation of the stored first segment of said program to the user;
receiving a second segment of said program at least L time units after beginning to store the first segment of said program; and
presenting to the user the second segment of said program when the presentation of the first segment of said program is completed.

2. The method of claim 1, further comprising the steps of:
storing program data included in the second segment of said program while presenting at least a portion of the first segment of said program to the user.

3. The method of claim 2, further comprising the steps of:
receiving program guide information; and
identifying, from the received program guide information, a broadcast channel upon which the second segment of said program is being broadcast.

4. The method of claim 3,
wherein the first segment of said program is an initial program segment;
wherein the second segment of said program is a main program segment; and
wherein the second segment of said program is received as part of a periodic broadcast of said first and second segments of said program.

5. The method of claim 3, further comprising the step of:
selecting, from a plurality of broadcast channels upon which the second segment of said program is being broadcast, one of said broadcast channels from which to receive the second segment of said program.

6. The method of claim 5, wherein the step of selecting one of said broadcast channels includes the step of selecting the first broadcast channel upon which the second segment of said program will be transmitted at or following the start of the presentation of the stored first segment of said program to the user.

7. The method of claim 6,
wherein the maximum delay between broadcasts of the second program segment during a fixed time interval is C time units, the step of storing a first segment of said program including the step of storing at least C time units of video data; and
wherein L>C.

8. The method of claim 6, wherein the maximum delay between broadcasts of the second program segment is C time units, the step of storing a first segment of said program including the step of storing at least Y time units of video data, where L>C≧Y.

9. The method of claim 6, wherein the method further comprises the step of:
broadcasting the first segment of said program which is stored, on a first communications channel, prior to performing the storing step; and
broadcasting the second segment of said program which is presented to the user on a second communications channel prior to performing the receiving step.

10. The method of claim 2, wherein the step of storing program data corresponding to the second segment of said program includes the step of storing program data in a portion of a cache which is operated as a first-in, first-out data structure.

11. The method of claim 10, wherein the step of:
beginning the presentation of the stored first segment of said program to the user includes the steps of:
performing at least one of a descrambling operation and a decrypting operation on at least some data included in the first segment of said program; and
outputting video data generated as a function of performing at least one of said descrambling operation and decrypting operation to a presentation device.

12. A method of providing a program to a user, comprising the steps of:
receiving on a first communications channel, a first program segment;
storing the first segment of said program in a storage device;
receiving a second program segment on a second communications channel, the first and second program segments corresponding to the same program; and
presenting to the user the second segment of said program immediately following the presentation of the first segment of said program.

13. The method of claim 12,
wherein the first and second communications channels are different physical communication channels with different carrier frequencies.

14. The method of claim 12,
wherein the first and second communications channels are different logical communication channels implemented using the same physical communications channel.

15. The method of claim 12,
wherein said program is a user selected program; and
wherein the first segment of said program is one of a first plurality of program segments transmitted on the first communications channel, the method further comprising the step of:
storing, in the storage device, additional program segments included in the first plurality of program segments; and
accessing information indicating which program segments correspond to said user selected program.

16. The method of claim 15, wherein the accessed information further includes information about the order in which the segments corresponding to the user selected program are to be presented.

17. The method of claim 16, wherein the accessed information indicates that a first one of the additional program segments is to be presented immediately following the second program segment, the method further comprising the step of:
presenting to the user a first one of the additional program segments immediately following the presentation of the second program segment.

18. The method of claim 17, further comprising the step of:
presenting to the user a second one of the additional program segments immediately following the presentation of the first additional program segment.

19. The method of claim 17,
wherein the first program segment is a regional news segment, the second program segment is a non-regional news segment, and the first additional program segment is a regional news segment.

20. The method of claim 12, wherein the second program segment is presented to the user without being stored in said storage device.

21. The method of claim 12, wherein the first program segment is a regional news segment, and the second program segment is a non-regional news segment.

22. The method of claim 12,
wherein the first segment of said program is an initial portion of a movie; and
wherein the second segment of said program is a main portion of said movie, the initial and main portions of said movie forming a complete version of said movie.

23. The method of claim 12, wherein the second segment of said program is a regional advertising segment.

24. The method of claim 12, further comprising the step of:
beginning the presentation of the stored first segment of said program to the user at or prior to performing the step of receiving a second segment of said program.

25. The method of claim 24, further comprising the step of:
storing at least a portion of the second program segment prior to presenting the second program segment to the user.

26. The method of claim 25,
wherein the first segment of said program is an initial portion of a movie; and
wherein the second segment of said program is a main portion of said movie, the initial and main portions of said movie forming a complete version of said movie.

27. A method of presenting a program to an individual, comprising the steps of:
operating a user device to record a broadcast of an initial portion of the program;
receiving information about the time and channel upon which copies of the program are broadcast;
operating the user device to detect a request to view said program;
in response to the request to view said program, operating the user device to begin presenting the initial portion of the program to the individual using the recorded initial portion of the program; and
operating the user device to obtain the data corresponding to a remaining portion of said program from one of said broadcast copies of said program.

28. The method of claim 27, further comprising the step of:
accessing said information about the time and channel upon which copies of the program are broadcast; and
selecting one of the broadcast copies from which to obtain the data corresponding to the remaining portion of said program as a function of the accessed information.

29. The method of claim 28, further comprising the step of:
presenting the remaining portion of said program to said individual immediately following the presentation of the initial portion of the program.

30. The method of claim 28, wherein the step of operating a user device to record a broadcast of an initial portion of the program includes the step of:
recording the initial portion of said program in a cache located on the premises of said individual.

31. The method of claim 30, further comprising the step of:
operating a video server to broadcast to the premises of multiple individuals, in a time staggered manner, copies of the said program.

32. The method of claim 31, wherein the program is a movie being provided as part of a pay per view service.

33. A method of providing regional and non-regional program data to a plurality of users, the method comprising the steps of:
broadcasting a plurality of regional program segments;
operating a plurality of user devices to store the regional program segments in a cache included in each of the plurality of user devices;
broadcasting program segment information about a plurality of regional programs, the program segment information for each regional program indicating the program segments included in the regional program;
broadcasting non-regional program segments after operating the user devices to store the regional program segments; and
operating the user device to present at least one regional program segment to the user by presenting at least one cached regional program segment and a broadcast non-regional program segment to the user.

34. The method of claim 33, wherein the broadcast program segment information further includes information about the time at which each of the program segments included in a regional program is to be presented.

35. The method of claim 34,
wherein the step of broadcasting a plurality of regional program segments includes the step of operating a satellite to transmit the regional program segments to the user device; and
wherein the user device is a satellite receiver located at the premises of one of a plurality of users.

36. The method of claim 33,
wherein the regional program segments are regional news segments and wherein the non-regional program segments are non-regional news segments.

37. The method of claim 33, wherein the regional program segments are regional advertising segments and the non-regional program segments are television program segments.

38. A user device for processing program data, comprising:
a receiver circuit for receiving broadcast program data;
a program cache coupled to the receiver circuit;
means for identifying and storing in said program cache initial portions of programs which are broadcast on a periodic basis;
means for detecting user input requesting the presentation one of the programs which are transmitted on a periodic basis;
means for outputting a cached initial portion of said user requested program in response to said user input requesting the presentation of one of the programs; and
means for obtaining, from a periodic broadcast of the user requested program which starts subsequent to caching of the initial portion of said user requested program, a remaining portion of said user requested program; and
means for outputting the remaining portion of said user requested program immediately following the output of the cached initial portion.

39. The user device of claim 38, wherein the means for obtaining, from a periodic broadcast of the user requested program, a remaining portion of said user requested program includes:
stored program guide information indicating the channels on which said programs are transmitted on a periodic basis and information on the time at which the programs are broadcast.

40. The user device of claim 39, wherein the means for outputting the remaining portion of said user requested program includes;
means for caching data representing the remaining portion of the program in the program cache in a first-in, first-out data structure.

41. The user device of claim 39, further comprising:
means for transmitting requests to view a user selected program.

42. A device for processing program segments, comprising:
a cache for storing program segments;
means for receiving on a first communications channel, a first program segment;
a cache controller for storing the program segment in the cache;
means for receiving a second program segment on a second communications channel, the first and second program segments corresponding to the same program; and
means for presenting to the user the second segment of said program immediately following the presentation of the first segment of said program.

43. The device of claim 42, further comprising:
means for accessing program information indicating which program segments are included in said program and the time at which at least one of the included program segments will be broadcast.

44. The device of claim 42, wherein the program is a movie, the first program segment is an initial portion of the movie and second program segment is a main portion of said movie.

45. The device of claim 43, wherein the program is a regional news program, wherein the first program segment is a regional news program segment; and wherein the second program segment is a non-regional news program segment.

46. The device of claim 39, wherein the second program segment is a regional advertising segment.

47. The device of claim 46, wherein the first program segment is a television program segment.

48. A system for presenting a program to an individual, comprising the steps of:
a server for broadcasting to the premises of multiple individuals, in a time staggered manner, copies of the program and information about the time and channel upon which copies of the program will be broadcast;
a user device in communication with said server, the user device including:
means for recording a broadcast of an initial portion of the program;
means for receiving information about the time and channel upon which copies of the program are broadcast;
means for detecting a request from a user to view said program;
means for presenting the recorded initial portion of the program, in response to the request to view said program, to the user; and
means for obtaining the data corresponding to a remaining portion of said program from a copy of said program.

49. A system for providing regional and non-regional news to a plurality of users, the system comprising:
a server for broadcasting a plurality of regional news segments, non-regional news segments and program information indicating the news segments included in each of a plurality of non-regional news segments;
a plurality of user devices in communication with said server, at least some of the user devices being located at different subscriber premises which are physically remote from each other and the server;
each of the plurality of said user devices including:
a cache for storing regional news segments;
means for accessing the broadcast program segment information to identify regional and non-regional news segments which are included in a non-regional news program;
means for presenting at least one regional news program by outputting at least one cached regional news segment and by outputting, immediately following the output regional news segment, at least one non-regional news segment corresponding included in the same regional news program as the output non-regional news segment.
